(19) United States
(12) Patent Application Publication
(10) Pub. No.: US 2010/0271275 A1
(43) Pub. Date: Oct. 28, 2010

(54) HDTV Antenna

(76) Inventors: Patrick Yen, Rancho Cucamonga, CA (US); Tony Huang, Corona, CA (US)

Correspondence Address: LAW OFFICES OF CLEMENT CHENG, 17220 NEWHOPE STREET #127, FOUNTAIN VALLEY, CA, 92708, US

(21) Appl. No.: 12/386,691

(22) Filed: Apr. 22, 2009

(51) Int. Cl. H01Q 11/12

(52) U.S. Cl. 343/742

(57) ABSTRACT

An antenna is adapted for receiving high-definition television HDTV signals and includes a first antenna coil, a second antenna coil, and transformer adapter. A pair of wire leads connect the transformer adapter to the first antenna coil and the second antenna coil. An output from the transformer adapter is for attaching to high definition television set. The antenna pair of coils are preferably made of copper. A width (“W”) between the first antenna coil and the second antenna coil has a range of (2 cm-6 cm). A thickness (“T”) of the wire has a range of approximately 1 mm (0.5 mm-3 mm). The antenna can be used in horizontal configuration.

### DISCUSSION OF RELATED ART

HDTV promises to provide greater bandwidth with less signal loss. Unfortunately, HDTV broadcast from television stations requires an antenna for receiving signals. Thus, an inexpensive antenna is preferred for receiving signals, since the digital nature of HDTV can hopefully compensate for inexpensive antenna hardware.

The present invention relates to an HDTV antenna design. A wide variety of HDTV antenna have been devised for receiving HDTV signals. The present invention is yet another HDTV antenna, but promises to be cost effective and easy to manufacture.

A wide variety of antenna designs are shown in the art, such as the Dual Frequency Bat Wing Antenna to Mahnad U.S. Pat. No. 5,497,166 issued Mar. 5, 1996 the disclosure of which is incorporated herein by reference. The abstract describes the antenna as having, “A dual frequency batwing antenna includes a larger batwing with smaller UHF batwings located in substantially the same plane but within a vacant space provided by the larger batwing. The smaller batwings are also co-linear so there is no inductive coupling. Thus a pair of radio frequency signals are radiated from a common aperture.”

A Low-Profile Television Antenna to McCollum U.S. Pat. No. 6,922,179 issued Jul. 26, 2005 is one of the more popular television antennas which has a grid type pattern for receiving signals, the disclosure of which is incorporated herein by reference. The abstract describes a reflector apparatus, “A television antenna formed from a pair of generally sinuous antenna arms extending outwardly from a common central axis and arranged opposite each other. The antenna arms do not interleave or touch each other. A reflector provides a separation distance between the reflector and the pair of antenna arms.”

### SUMMARY OF THE INVENTION

The invention is an antenna design that has a pair of copper coil. The copper coil pair are pointed in the general direction of a signal for receiving signals and passing those signals to a transformer which sends the signal to an HDTV television. The coil configuration required is novel and does not appear in the prior art.

### BRIEF DESCRIPTION OF THE DRAWINGS

FIG. 1 is a diagram of the present invention.

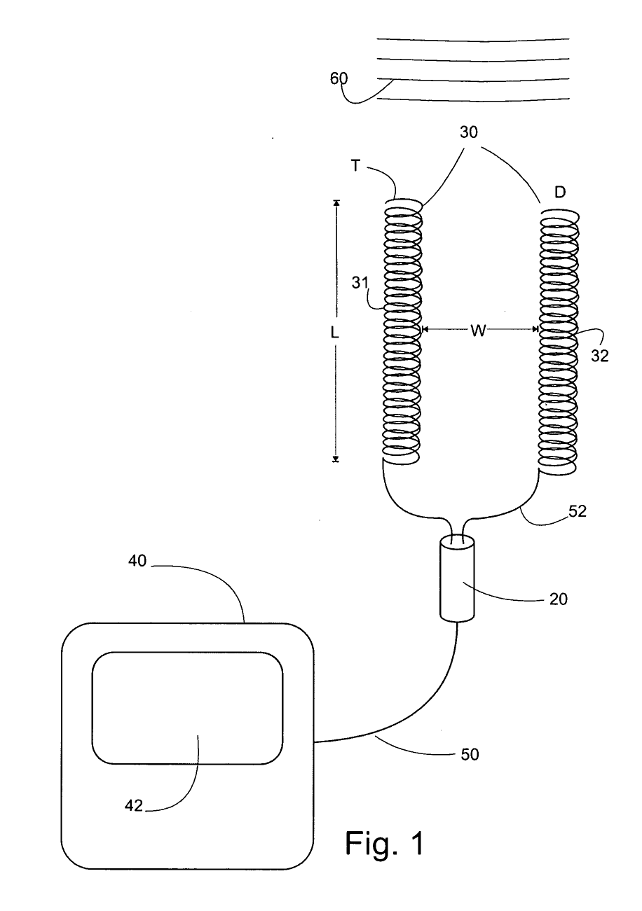

The drawings have the following call elements listed below for convenience in reference:
20 Television Transformer
30 Coil Pair
31 First Coil
32 Second Coil
40 Television
42 Television Screen
50 Coaxial Cable
52 Wire Leads
60 Signal

### DETAILED DESCRIPTION OF THE PREFERRED EMBODIMENT

The preferred mode for the antenna is to point the antenna toward the signal 60. The antenna is preferably mounted on a pivot frame. The antenna can be mounted inside a box and the box can be placed on a television set, or on a console table and pointed toward the signal. The antenna is made of a pair of coils 30, namely a first coil 31 and a second coil 32. The first coil 31 and the second coil 32 are connected to a transformer 20, which connects the antenna to the television 40 by the coaxial cable 50. The television shows the signal 60 on the screen 42.

The preferred transformer is the Gemini Model cv 70, or a transformer such as that which is commonly and commercially available. The parameters are preferably as follows:
The pair of coils in are preferably made of copper
A width (“W”) between the coils of approximately 3.5 cm (2 cm-6 cm)
A copper thickness (“T”) of approximately 1 mm (0.5 mm-3 mm)
A length (“L”) of approximately 11 cm (6 cm-19 cm)
A coil diameter (“D”) of approximately 8 mm (4 mm-16 mm)
A total of approximately 24 windings is preferably (12 windings-36 windings)

The signal 60 hits the coil pair 30 which is most likely horizontally oriented. The coil pair 30 has a copper construction and is preferably copper wire. The copper wire or copper clad wire has a length of preferably approximately 11 cm and can be anywhere between 6 cm and 19 cm. The coil diameter is preferably approximately 8 cm and can be anywhere between 4 mm and 16 mm.

The coil pair has a free end, and a base end. The wire leads 52 extend from the base ends of the coils. The wire leads 52 are preferably soldered to the copper coil, and can be extensions of the copper coil which are not wound in a coil. Additionally, the components such as the pair of coils 30, the wire leads 52 and the television transformer adapter 20 are preferably mounted in a plastic box. The transformer adapter provides an output which is preferably on a coaxial cable.

The entire device preferably fits within a small space.

1. An antenna adapted for receiving HDTV signals comprising:
a. a first antenna coil;
b. a second antenna coil;
c. a transformer adapter, wherein a pair of wire leads connect the transformer adapter to the first antenna coil and the second antenna coil;
d. an output from the transformer adapter, for attaching to high definition television set.

2. The antenna of claim 1, wherein the pair of coils are made of copper.

3. The antenna of claim 1, wherein a width (“W”) between the first antenna coil and the second antenna coil has a range of (2 cm-6 cm).

4. The antenna of claim 1, wherein a thickness (“T”) of the wire has a range of approximately 1 mm (0.5 mm-3 mm).

5. The antenna of claim 1, wherein a length (“L”) of the first antenna coil and the second antenna coil is has a range of (6 cm-19 cm).

6. The antenna of claim 1, wherein a coil diameter (“D”) of the first antenna coil and the second antenna coil has a range of (4 mm-16 mm).

7. The antenna of claim 1, wherein the number of windings in the first antenna coil and the number of windings in the second antenna coil both have a range of (12 windings-36 windings).

8. The antenna of claim 1, wherein a width (“W”) between the first antenna coil and the second antenna coil has a range of (2 cm-6 cm), wherein a thickness (“T”) of the wire has a range of approximately 1 mm (0.5 mm-3 mm).

9. The antenna of claim 1, wherein a width (“W”) between the first antenna coil and the second antenna coil has a range of (2 cm-6 cm), wherein a length (“L”) of the first antenna coil and the second antenna coil is has a range of (6 cm-19 cm).

10. The antenna of claim 1, wherein a width (“W”) between the first antenna coil and the second antenna coil has a range of (2 cm-6 cm), wherein a thickness (“T”) of the wire has a range of approximately 1 mm (0.5 mm-3 mm), wherein a length (“L”) of the first antenna coil and the second antenna coil is has a range of (6 cm-19 cm), wherein a coil diameter (“D”) of the first antenna coil and the second antenna coil has a range of (4 mm-16 mm), wherein the number of windings in the first antenna coil and the number of windings in the second antenna coil both have a range of (12 windings-36 windings).

11. The antenna of claim 1, wherein a thickness (“T”) of the wire has a range of approximately 1 mm (0.5 mm-3 mm), wherein a length (“L”) of the first antenna coil and the second antenna coil is has a range of (6 cm-19 cm), wherein a coil diameter (“D”) of the first antenna coil and the second antenna coil has a range of (4 mm-16 mm), wherein the number of windings in the first antenna coil and the number of windings in the second antenna coil both have a range of (12 windings-36 windings).

12. The antenna of claim 1, wherein the pair of coils in are made of copper, wherein the output is by coaxial cable.

13. The antenna of claim 12, wherein a width (“W”) between the first antenna coil and the second antenna coil has a range of (2 cm-6 cm), wherein a thickness (“T”) of the wire has a range of approximately 1 mm (0.5 mm-3 mm).

14. The antenna of claim 12, wherein a width (“W”) between the first antenna coil and the second antenna coil has a range of (2 cm-6 cm), wherein a length (“L”) of the first antenna coil and the second antenna coil is has a range of (6 cm-19 cm).

15. The antenna of claim 12, wherein a width (“W”) between the first antenna coil and the second antenna coil has a range of (2 cm-6 cm), wherein a thickness (“T”) of the wire has a range of approximately 1 mm (0.5 mm-3 mm), wherein a length (“L”) of the first antenna coil and the second antenna coil is has a range of (6 cm-19 cm), wherein a coil diameter (“D”) of the first antenna coil and the second antenna coil has a range of (4 mm-16 mm), wherein the number of windings in the first antenna coil and the number of windings in the second antenna coil both have a range of (12 windings-36 windings).

16. The antenna of claim 12, wherein a thickness (“T”) of the wire has a range of approximately 1 mm (0.5 mm-3 mm), wherein a length (“L”) of the first antenna coil and the second antenna coil is has a range of (6 cm-19 cm), wherein a coil diameter (“D”) of the first antenna coil and the second antenna coil has a range of (4 mm-16 mm), wherein the number of windings in the first antenna coil and the number of windings in the second antenna coil both have a range of (12 windings-36 windings).
